(19) United States
(12) Patent Application Publication
(10) Pub. No.: US 2009/0283103 A1
(43) Pub. Date: Nov. 19, 2009

(54) ELECTRONIC VAPORIZING DEVICES AND DOCKING STATIONS

(76) Inventors: Michael D. Nielsen, Glendale, AZ (US); John R. Leadbeater, Scottsdale, AZ (US); James G. Palasota, Scottsdale, AZ (US)

Correspondence Address: WEISS & MOY PC, 4204 NORTH BROWN AVENUE, SCOTTSDALE, AZ, 85251, US

(21) Appl. No.: 12/465,551

(22) Filed: May 13, 2009

Related U.S. Application Data
(60) Provisional application No. 61/052,691, filed on May 13, 2008.

(51) Int. Cl. A24F 47/00; H02J 7/00

(52) U.S. Cl. 131/273; 320/107

(57) ABSTRACT

A docking station for an electronic vaporizing device (EVD), the docking station includes: a housing; one or more charging slots in the housing for a plurality of spare batteries for use in the EVD; a dedicated charging slot in the housing for engaging the EVD to charge the EVD's battery; wherein the plurality of spare batteries are used as replacements for the EVD's battery; and an AC/DC charger connected to an AC electrical plug receptacle for charging a main battery that powers the docking station.

### RELATED APPLICATIONS

This application is a related to U.S. Provisional Application Ser. No. 61/052,691, Filed May 13, 2008, in the name of the same inventors listed above, and entitled “ELECTRONIC VAPORIZING DEVICE”. The present application claims the benefit to the aforementioned provisional application.

### FIELD OF THE INVENTION

This invention relates to inhalation devices, and more specifically, to improved electronic vaporizing devices (EVD) and docking stations that provide a heated or non-heated vapor for inhalation utilizing liquid substances.

### BACKGROUND OF THE INVENTION

Electronic cigarettes (e-cigarettes) are a revolutionary new smoking alternative that looks, feels, and tastes like a cigarette or cigar, and gives smokers all the pleasure and satisfaction of traditional smoking without all the health, social and economic problems. An e-cigarette is driven by modern microelectronic technology, a small rechargeable battery and a unique replaceable cartridge and membrane containing water, propylene glycol, nicotine, and a scent that emulates tobacco and other flavorings. The act of inhaling (smoking) an e-cigarette produces the tactile and craving satisfactions smokers seek, and triggers a vaporizing process that releases simulated smoke which is actually a vapor mist that evaporates into the air within a few seconds. Thus, an e-cigarette replicates the behavioral and physical pleasures of smoking.

While e-cigarettes are a remarkable facsimile of traditional smoking products that replicate the behavioral and physical pleasures of smoking, e-cigarettes avoid the problems and short comings of traditional smoking products. E-cigarettes are virtually odorless, avoid first and secondhand smoke concerns, contain no known carcinogens, are non flammable, and are a lower cost alternative than traditional smoking products.

### SUMMARY OF THE INVENTION

A docking station for an electronic vaporizing device (EVD), the docking station includes: a housing; one or more charging slots in the housing for a plurality of spare batteries for use in the EVD; a dedicated charging slot in the housing for engaging the EVD to charge the EVD's battery; wherein the plurality of spare batteries are used as replacements for the EVD's battery; and an AC/DC charger connected to an AC electrical plug receptacle for charging a main battery that powers the docking station.

An electronic vaporizing device (EVD) cylindrical canister includes: an AC/DC charger connected to an AC electrical plug receptacle for charging a main battery that powers the EVD cylindrical canister; a sealed cartridge chamber containing a liquid; a wicking system that penetrates the sealed cartridge chamber and facilitates the flow of the liquid to a vaporizer; wherein the vaporizer converts the liquid into a vapor that is outputted into a vapor tube that is joined to a straw that is external to the cylindrical canister; and wherein the EVD cylindrical canister is dimensioned to mimic popular energy drink or beverage cans.

A hookah includes: a plurality of pipes individually configured with separate EVD; and wherein a vapor flavor selection for a particular pipe, from the plurality of pipes, is determined by a liquid cartridge selected for the particular pipe's EVD.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description of exemplary embodiments of the present invention taken in conjunction with the accompanying drawings in which:

FIG. 1A is a perspective view of an electronic vaporizing device (EVD) engaged in a docking station in the form of a cigarette pack according to embodiments of the invention.

FIG. 1B is a side view of the EVD engaged in the docking station of FIG. 1A with a retractable AC/DC plug receptacle deployed according to embodiments of the invention.

FIG. 1C is a side view of the EVD engaged in the docking station of FIG. 1A configured with a data port or slot with the retractable AC/DC plug receptacle deployed according to embodiments of the invention.

FIG. 1D is a side view of the EVD engaged in the docking station of FIG. 1A configured with an electronic information display according to embodiments of the invention.

FIG. 1E is a cross-sectional view of the docking station of FIG. 1A, taken along line 1E-1E showing the interior features of the docking station, the EVD engaged, and an additional battery present according to embodiments of the invention.

FIG. 1F is a cross-sectional view of the EVD of FIG. 1E, taken along line 1F-1F showing the interior features of the EVD according to embodiments of the invention.

FIG. 2 is a cross-sectional view of an EVD type device configured in a container in the form of a cylindrical canister according to embodiments of the invention.

FIG. 3 illustrates the EVD of FIGS. 1A-1F engaged in a docking station in electrical communication with a computing device according to embodiments of the invention.

FIG. 4A is a perspective view of an electronic vaporizing device (EVD) engaged in a docking station with audio/video capabilities in the form of a cigarette pack according to embodiments of the invention.

FIG. 4B is a side view of the docking station of FIG. 4A being supported by a retractable viewing stand according to embodiments of the invention.

FIG. 5 is a hookah pipe configured with individual EVD for a plurality of simultaneous users according to embodiments of the invention.

The detailed description explains exemplary embodiments of the present invention, together with advantages and features, by way of example with reference to the drawings.

### DETAILED DESCRIPTION OF EXEMPLARY EMBODIMENTS

While the specification concludes with claims defining the features of the invention that are regarded as novel, it is believed that the invention will be better understood from a consideration of the description of exemplary embodiments in conjunction with the drawings. It is of course to be understood that the embodiments described herein are merely exemplary of the invention, which can be embodied in various forms. Therefore, specific structural and functional details disclosed in relation to the exemplary embodiments described herein are not to be interpreted as limiting, but merely as a representative basis for teaching one skilled in the art to variously employ the present invention in virtually any appropriate form. Further, the terms and phrases used herein are not intended to be limiting but rather to provide an understandable description of the invention.

Exemplary embodiments of the present invention provide an improved electronic vaporizing device (EVD) that produces a heated or non heated vapor utilizing liquid substances. The EVD, of embodiments of the invention, utilizes one or more piezo-micro screens to covert a liquid substance into a liquid water-like vapor. The EVD is configured with a cartridge chamber filled with the liquid substance that is delivered to the vaporizing system of the EVD. Embodiments of the improved electronic vaporizing device may be powered by a replaceable and/or rechargeable battery, or other form of electrical current. The components and features of the EVD may or may not be controlled by a microprocessor.

In embodiments of the EVD, a piezo device is utilized to vibrate one or more micro screens of varying sizes to produce a vapor from the liquid. A piezo device creates a vibrating effect when an electric charge or other form of energy is applied to the piezoelectric/micro screen(s) device. The one or more micro screen(s) are layers of pre-fabricated electroformed screen(s) made from an alloy, such as a nickel alloy. The vaporization of a liquid in the EVD process is accomplished by passing the liquid through the one or more vibrating micro screens. The vibration of the micro screen(s) causes a liquid to break-down or atomize into particles, thus producing a vapor. Liquid mixtures to be vaporized for user inhalation from the EVD include, but are not limited to: nicotine, caffeine, vitamins, energy drinks, supplements, insulin, medications, coffee, sodas, candy, ice cream, alcohol, natural extracts and flavors.

Embodiments of the electronic vaporizing device may be activated by a user's inhaling or sucking action, or by an on/off mechanism or switch. In embodiments of the invention, a solid state air flow sensor or an on/off mechanism or switch may act as the switching device to activate a microprocessor, the piezo, one or more micro screen(s), and a heating element. The heating element provides users of the EVD with the option of having a vapor heated when the vapor passes by or across the heating element prior to inhalation. When not in use, the EVD remains in a stand-by mode.

Embodiments of the EVD are configured with a sealed cartridge chamber that is filled with a liquid substance determined by the user. Upon a user's insertion of the sealed cartridge chamber into the EVD, the seal of the cartridge chamber is penetrated by a wicking system that interfaces with the micro screen(s). The wicking system comprises a small needle or object that pierces the sealed cartridge chamber. The piercing of the cartridge chamber allows the liquid substance to flow to the micro screen(s) in the event the EVD is activated. A small seal is installed around the piercing needle or object to prevent unintended liquid leakage from the cartridge.

Embodiments of the EVD may be configured with an on-board microprocessor for controlling features of the EVD. For example, the microprocessor may monitor consumption and levels of liquid in the cartridge chamber, and time of use of the EVD. In addition, the EVD's microprocessor may control tactile, audio, and/or visual feedback to the user. User feedback may include a small vibration motor installed in the EVD that will vibrate the EVD, or other forms of notification i.e., light or audio alarm that provide notification signals to the user relative to consumption, battery status, or other operating features of the EVD. In an exemplary embodiment, a user will be notified by the EVD vibrating or signaling one time, or any designated number of times, after consuming the equivalent of one traditional dose, or any measurement, of the intended substitute substance; for example, if the device is a smoking alternative, the EVD would vibrate after 10-20 puffs to indicate the equivalent of one cigarette's worth of nicotine, or any other predetermined number of measuring units. The EVD will also notify the user when a battery has a low charge and requires the battery to be recharged. Additional embodiments of the EVD may include a viewing-window to enable a user to visually monitor the level of fluid in the liquid cartridge.

Embodiments of the EVD are self contained units that house the vaporizing chamber, cartridge, piezo, micro screen(s), heating apparatus (if required), vibration device, battery, and other components required to operate the device. A typical size of the electronic vaporizing device is equivalent to a standard tobacco cigarette (length 70 mm and circumference 25 mm), but additional embodiments of the EVD may be in any shape or size of enclosure that will house the vaporizing chamber, cartridge, piezo, micro screen(s), heating apparatus (if required), vibration device, cartridge, battery, and other components required to operate the device.

In embodiments of the invention, the EVD may be stored and charged in a docking station. The docking station may store data relative to consumption. The data may then be viewed on a display device native to the docking station, or on a user's personal computer in electrical communication contact with the docking station.

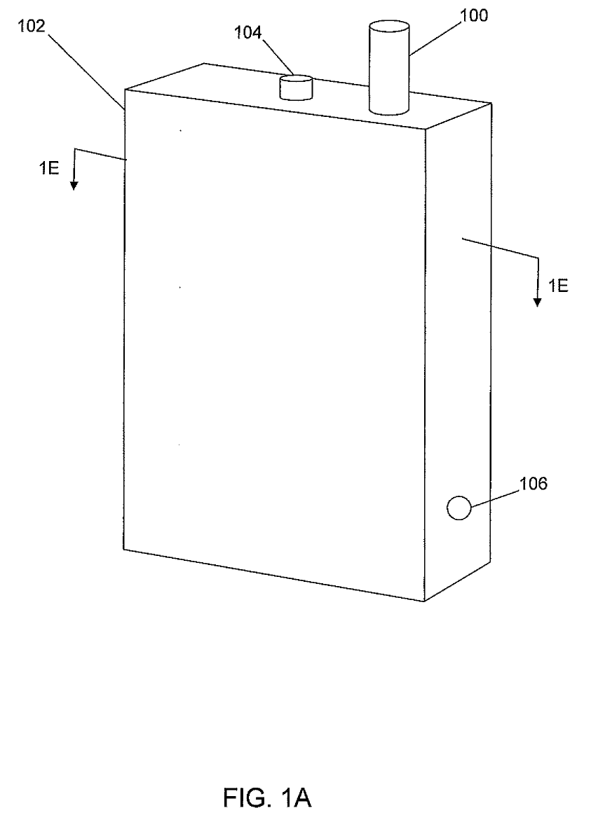

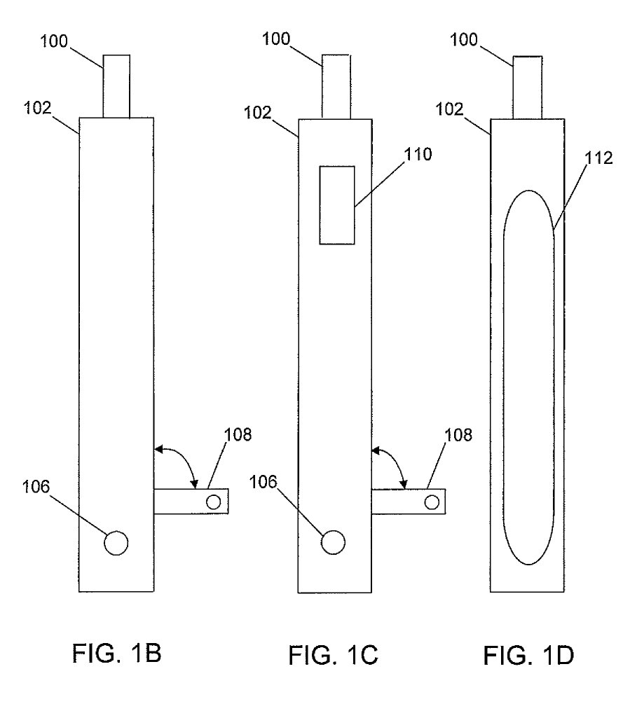

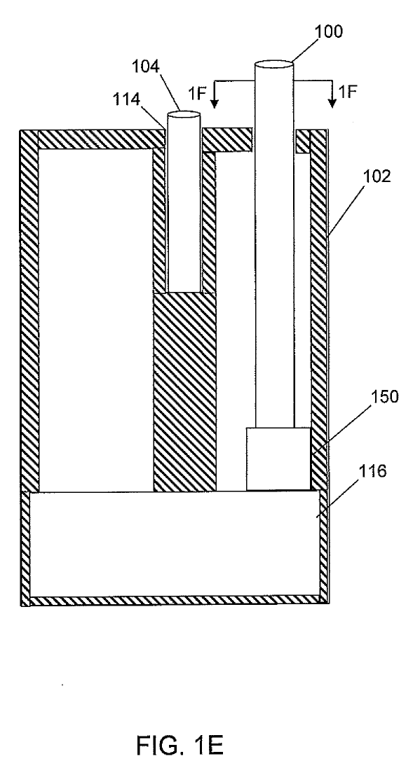

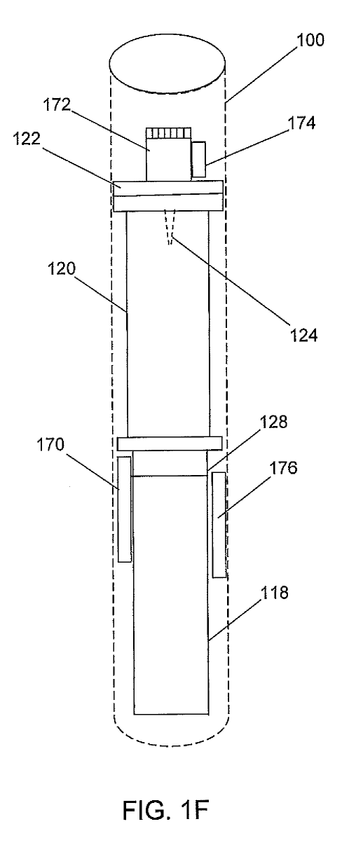

Referring now to figures, FIGS. 1A-1E illustrate a docking station 102 in the form of a cigarette pack (herein referred to as a NPAK) according to embodiments of the invention. FIG. 1A is a perspective view of an electronic vaporizing device (EVD) 100 engaged in a NPAK docking station 102. The NPAK docking station 102 has typical dimensions of approximately 1″ to 4″ length, by 1″ to 6″ height, and from ¼ ″ to 4″ width. The NPAK 102 may have one or more additional battery(ies) 104 sitting in one or more port(s) or slot(s) 114 (see FIG. 1E) for insertion into the EVD. The one or more additional batteries 104 are charged with an AC/DC charger 150. A main battery 116, and as well as the removable battery 118 (replaced with the additional battery 104) within the EVD 100 (when inserted in the NPAK 102) are charged by the AC/DC charger 150. The NPAK 102 may be configured with one or more slots 114 for devices, batteries, cartridges 120 (see FIG. 1F), or other accessories and devices. An indicator light 106 may be configured to indicate operation status parameters including, but not limited to, whether the NPAK 102 is on or off, and battery charging status.

FIG. 1B is a side view of the EVD 100 engaged in the docking station (NPAK) 102 of FIG. 1A with a retractable AC/DC plug receptacle 108 deployed according to embodiments of the invention. The deployed AC/DC plug receptacle 108 may be inserted (plugged) into an AC electrical receptacle (not shown) for recharging the one or more addition batteries 104, the main battery 116, and the EVD's battery 118 in the event the EVD 100 is inserted in the NPAK 102. The retractable AC/DC plug receptacle 108 is electrically connected to a AC/DC charger 150.

FIG. 1C is a side view of the EVD 100 engaged in a docking station 102 of FIG. 1A with a data port or slot 110 with the retractable AC/DC plug receptacle 108 deployed according to embodiments of the invention. The data port 110 may be configured to accept external memory devices, data transfer cables (i.e., universal serial bus (USB), firewire, etc.), or wireless data transfer adaptors (i.e., Bluetooth, WiFi, IEEE 811 standards, etc.).

FIG. 1D is a side view of the EVD 100 engaged in the docking station of FIG. 1A configured with an electronic information display 112 according to embodiments of the invention. The electronic information display 112 may be used to display status information for the NPAK 102, the EVD 100 (when engaged in the NPAK 102), as well as, entertainment information such as for track selection for playback of various data formats including, but not limited to, a MP3 player.

FIG. 1E is a cross-sectional view of the NPAK docking station 102 of FIG. 1A, taken along line 1E-1E illustrating the interior features of the docking station, and the EVD 100 engaged and the additional battery 104 inserted and engaged in slot 114 according to embodiments of the invention. The AC/DC charger 150 is electrically connected to a rechargeable permanent high capacity battery 116. The high capacity battery 116 powers the features of the NPAK 102, and may be used to recharge the EVD's battery 118 and the one or more additional batteries 104 in the event the NPAK 102 is not plugged into an AC electric source.

FIG. 1F is a cross-sectional view of the EVD 100 of FIG. 1E, taken along line 1F-1F showing the interior features of the EVD 100 according to embodiments of the invention. The EVD 100 is a self contained unit that houses the vaporizing chamber 172, cartridge 118, piezo, micro screen(s) 122, on/off switch 170, heating apparatus 174 (if required), vibration device 176, battery 118, and other components required to operate the device. A typical size of the electronic vaporizing device 100 is equivalent to a standard tobacco cigarette (length 70 mm and circumference 25 mm), but additional embodiments of the EVD may be in any shape or size of enclosure that will house the vaporizing chamber, cartridge, piezo, micro screen(s), heating apparatus (if required), vibration device, cartridge, battery, and other components required to operate the device.

The EVD 100 is configured with a sealed cartridge chamber 120 that is filled with a liquid substance determined by the user. Upon a user's insertion of the sealed cartridge chamber 120 into the EVD 100, the seal of the cartridge chamber 120 is penetrated by a wicking system that interfaces with the micro screen(s). The wicking system comprises a small needle 124 or object that pierces the sealed cartridge chamber 120. The piercing of the cartridge chamber 120 allows the liquid substance to flow to the micro screen(s) 122 in the event the EVD is activated. A small seal (not shown) is installed around the piercing needle 124 or object to prevent unintended liquid leakage from the cartridge 120.

Continuing with FIG. 1F, the EVD 100 may be configured with an on-board microprocessor 128 for controlling features of the EVD 100. For example, the microprocessor 128 may monitor consumption and levels of liquid in the cartridge chamber 120, and time of use of the EVD 100. In addition, the EVD's microprocessor 128 may control tactile, audio, and/or visual feedback to the user. User feedback may include a small vibration motor 176 installed in the EVD 100 that will vibrate the EVD 100, or other forms of notification i.e., light or audio alarm that provide notification signals to the user relative to consumption, battery status, or other operating features of the EVD 100.

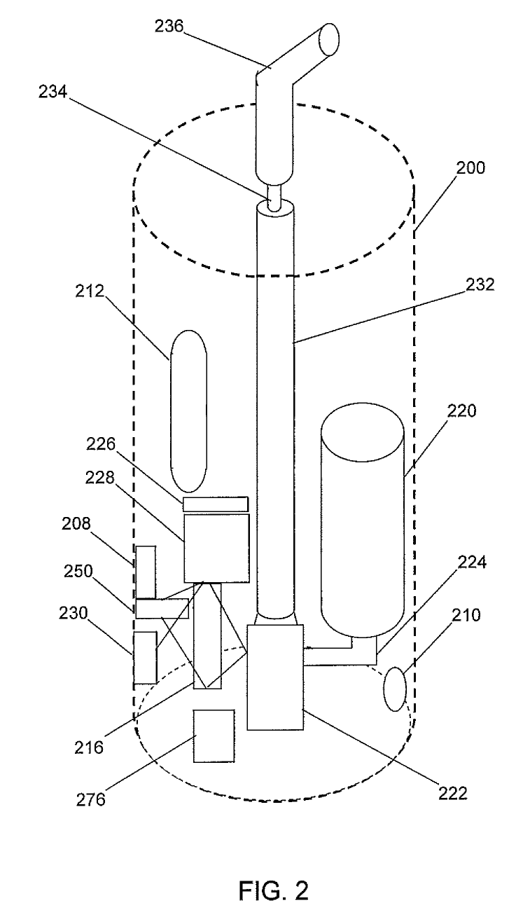

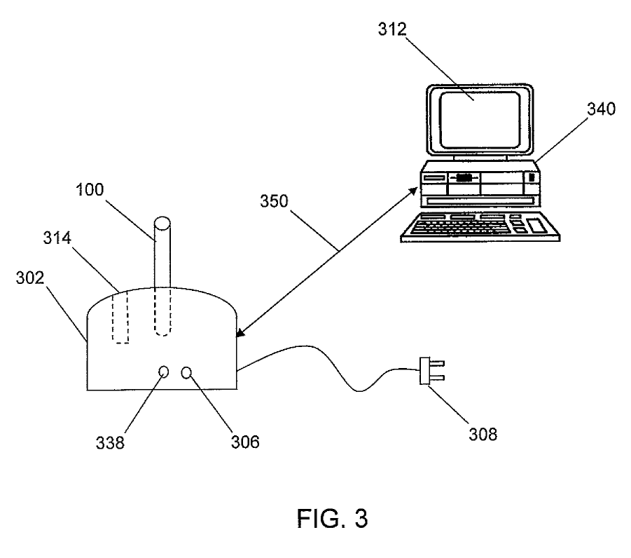

FIG. 2 is a cross-sectional view of an EVD type device configured in a container in the form of an EVD cylindrical canister (herein referred to as a NCAN) 200 according to embodiments of the invention. The NCAN 200 is designed to mimic popular energy drink or beverage cans. The NCAN 200 operates based the same technology as described for the EVD 100, or on other liquid vaporization technologies. Liquid mixtures to be vaporized for user inhalation from the NCAN 200 include, but are not limited to: nicotine, caffeine, vitamins, energy drinks, supplements, insulin, medications, coffee, sodas, candy, ice cream, alcohol, natural extracts and flavors.

The NCAN 200 is configured with a sealed cartridge chamber 220 that is filled with a liquid substance determined by the user. Upon a user's insertion of the sealed cartridge chamber 220 into the NCAN 200, the seal of the cartridge chamber 220 is penetrated by a wicking system 224 that interfaces with a vaporizer 220. The wicking system 224 comprises a small needle or object (not shown) that pierces the sealed cartridge chamber 220. The piercing of the cartridge chamber 220 allows the liquid substance to flow to the vaporizer 222 in the event the NCAN 200 is activated. A small seal (not shown) is installed around the piercing needle or object of the wicking system 224 to prevent unintended liquid leakage from the cartridge 220. The vaporizer 222 outputs a vapor into a vapor tube 232. The vapor tube 232 mates up to an external straw 236 via a straw plug 234 for delivery of the vaporized liquid to the user.

The NCAN 200 may be configured with an on-board microprocessor/memory 228 for controlling and providing features of the NCAN 200. For example, the microprocessor/memory 228 may monitor consumption and levels of liquid in the cartridge chamber 220, and time of use of the NCAN 200. In addition, the NCAN's microprocessor 228 may control tactile, audio, and/or visual feedback via display 212 to the user. User feedback may include a small vibration motor 276 installed in the NCAN 200 that will vibrate the NCAN 200, or other forms of notification i.e., light or audio alarm that provide notification signals to the user relative to consumption, battery status, or other operating features of the NCAN 200.

The NCAN 200 is powered via a retractable AC/DC plug receptacle 208 that is electrically connected to an AC/DC charger 250. The AC/DC charger 250 is electrically connected to a rechargeable permanent high capacity battery 216. The high capacity battery 216 powers the features of the NCAN 200. An on/off switch 230 controls the function of the high capacity battery 216.

Continuing with FIG. 2, the electronic information display 112 may be used to display entertainment information such as for track selection for playback of various data formats including, but not limited to, a MP3 player. Entertainment software and content may be stored in memory 228. A data port 210 may be configured to accept external memory devices, data transfer cables (i.e., universal serial bus (USB), firewire, etc.), or wireless data transfer adaptors (i.e., Bluetooth, WiFi, IEEE 811 standards, etc.). Entertainment content may be accessed via headphone jack 226.

FIG. 3 illustrates the EVD 100 of FIGS. 1A-1F engaged in a docking station 302 in electrical data transfer and communication (as signified by bidirectional arrow 350) with a computing device 340 according to embodiments of the invention. Data transfer between the docking station 302 and the computing device 340 may be via data transfer cables (i.e., universal serial bus (USB), firewire, etc.), or wireless data transfer adaptors (i.e., Bluetooth, WiFi, IEEE 811 standards, etc.). An electronic information display 312 of the computing device 340 may be used to display usage and status information for the engaged EVD 100. The docking station 302 is powered via an AC plug receptacle 308 that is electrically connected to a AC/DC charger (not shown) for charging the battery 118 of the EVD 100. One or more additional spare batteries 104 may be inserted into the docking station for charging in slot 314. The colored indicator lights may be used to indicate charging status. For example, red indicator light 338 may indicate a battery is charging, and green indicator light 306 illuminates in the event a rechargeable battery has been fully charged.

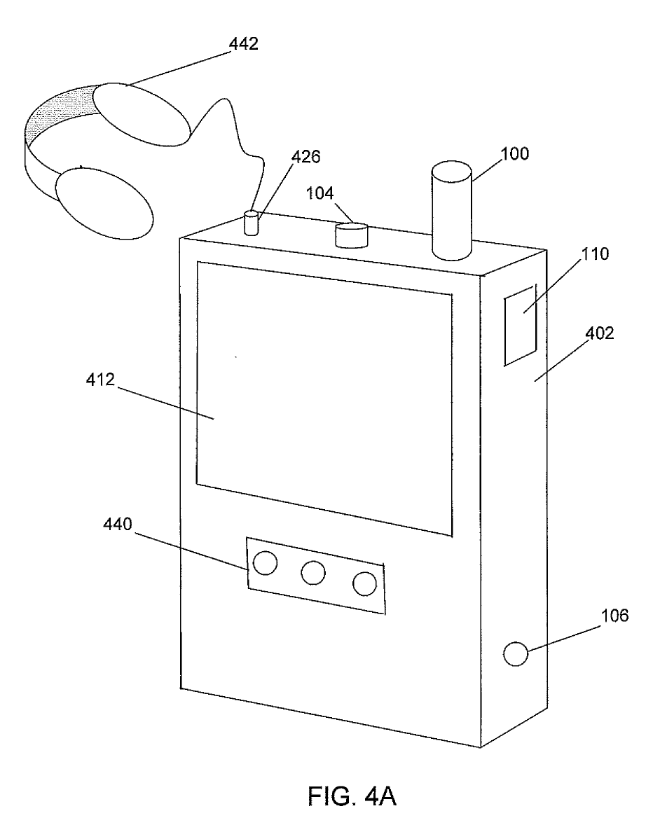

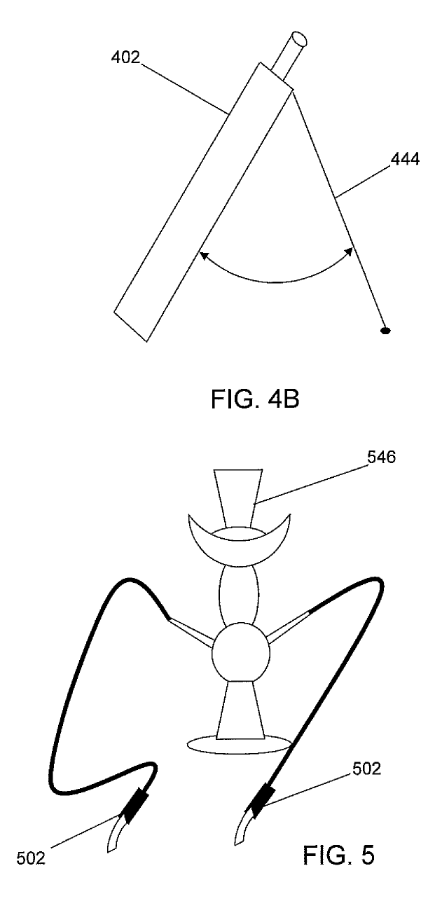

FIG. 4A is a perspective view of an electronic vaporizing device (EVD) engaged in a docking station 402 with audio/video capabilities (herein referred to as a NTV) in the form of a cigarette pack according to embodiments of the invention. The NTV 402 is operationally equivalent to the NPAK 102 with additional audio/video (A/V) capabilities and features. The electronic information display 412 may be used to display A/V entertainment information such as for track selection for playback of various data formats including, but not limited to, a MP3, video, and picture content. Entertainment software and content may be stored in on board memory (not shown). A data port 110 may be configured to accept external memory devices, data transfer cables (i.e., universal serial bus (USB), firewire, etc.), or wireless data transfer adaptors (i.e., Bluetooth, WiFi, IEEE 811 standards, etch). Entertainment content may be heard via headphone jack 426 with headphones 442, and accessed via controls 440, or via touch sensitive screen controls on the electronic information display 412. FIG. 4B is a side view of the NTV docking station 402 of FIG. 4A being supported by a retractable viewing stand 444 according to embodiments of the invention.

FIG. 5 is a hookah pipe 546 configured with individual EVD 502 for a plurality of simultaneous users according to embodiments of the invention. The hookah pipe 546 is modular in order to add EVD 502 depending on the size of the hookah pipe 546 needed to accommodate the number of potential users. In an exemplary embodiment up to 200 individual users may be accommodated. In embodiments of the invention, each individual pipe may or may not have its own electronic vaporizing device (EVD) 502, thereby allowing each individual user to select their own flavor for the pipe that they are using. The flavor selection of the user's pipe is controlled by a liquid cartridge selected for the (EVD). The hookah pipe 546 may either be portable by using a battery (not shown), or be stationary with an AC/DC outlet plug (not shown) to power the hookah pipe 546. There may be an on/off switching device (not shown) for each individual EVD pipe 502 so that only the EVD pipes 502 in use are turned on, or the user may turn on as many pipes as they choose. The hookah pipe 502 may contain an on/off switch for a heating option allowing user(s) to choose whether to heat the vapor in each individual EVD pipe 502. The user(s) of the hookah pipe will have a choice of multiple liquids including, but not limited to nicotine, nutraceuticals, coffee, caffeine, insulin, vitamins, energy drink, natural extracts, etc., which are contained in the replaceable cartridges (not shown) of the EVD pipes 502.

While exemplary embodiments of the present invention have been described, it will be understood that those skilled in the art, both now and in the future, may make various modifications without departing from the spirit and the scope of the present invention as set forth in the following claims. These following claims should be construed to maintain the proper protection for the present invention.

What is claimed is:

1. A docking station for an electronic vaporizing device (EVD), the docking station comprising:
a housing;
one or more charging slots in the housing for a plurality of spare batteries for use in the EVD;
a dedicated charging slot in the housing for engaging the EVD to charge the EVD's battery;
wherein the plurality of spare batteries are used as replacements for the EVD's battery; and
an AC/DC charger connected to an AC electrical plug receptacle for charging a main battery that powers the docking station.

2. The docking station of claim 1, further comprising:
a data port configured to accept external memory devices, data transfer cables, and wireless data transfer adaptors.

3. The docking station of claim 1, further comprising:
an electronic information display configured to display usage and status information for the engaged EVD.

4. The docking station of claim 1, further comprising:
an electronic information display configured to display and playback audio/video (A/V) entertainment information.

5. The docking station of claim 1, further comprising:
a headphone jack for outputting audio.

6. The docking station of claim 1, wherein the AC electrical plug receptacle retracts into the housing.

7. The docking station of claim 1, further comprising:
a retractable viewing stand that retracts into the housing.

8. The docking station of claim 1, wherein the housing has a series of dimensions that approximates a cigarette pack.

9. An electronic vaporizing device (EVD) cylindrical canister comprising:
an AC/DC charger connected to an AC electrical plug receptacle for charging a main battery that powers the EVD cylindrical canister;
a sealed cartridge chamber containing a liquid;
a wicking system that penetrates the sealed cartridge chamber and facilitates the flow of the liquid to a vaporizer;
wherein the vaporizer converts the liquid into a vapor that is outputted into a vapor tube that is joined to a straw that is external to the cylindrical canister; and
wherein the EVD cylindrical canister is dimensioned to mimic popular energy drink or beverage cans.

10. The EVD cylindrical canister of claim 9, further comprising:
a data port configured to accept external memory devices, data transfer cables, and wireless data transfer adaptors.

11. The EVD cylindrical canister of claim 9, further comprising:
an electronic information display configured to display usage and status information for the EVD.

12. The EVD cylindrical canister of claim 9, further comprising:
an electronic information display configured to display and playback audio/video (A/V) entertainment information.

13. The EVD cylindrical canister of claim 9, further comprising:
a headphone jack for outputting audio.

14. The EVD cylindrical canister of claim 9, further comprising:
a vibration motor that provides tactile feedback.

15. The EVD cylindrical canister of claim 9, wherein the liquid to be vaporized include, but are not limited to: nicotine, caffeine, vitamins, energy drinks, supplements, insulin, medications, coffee, sodas, candy, ice cream, alcohol, natural extracts and flavors.

16. A hookah comprising:
a plurality of pipes individually configured with separate EVD; and
wherein a vapor flavor selection for a particular pipe from the plurality of pipes is determined by a liquid cartridge selected for the particular pipe's EVD.

17. The hookah of claim 16, wherein the separate EVD are configured with an on/off switch for controlling a heater, thereby allowing a user to choose whether to heat the vapor in their individual pipe.

18. The hookah of claim 16, wherein the hookah is powered via an AC/DC outlet plug.

19. The hookah of claim 16, wherein the separate EVD are configured with on/off switches.

20. The hookah of claim 16, wherein the liquid to be vaporized include, but are not limited to: nicotine, caffeine, vitamins, energy drinks, supplements, insulin, medications, coffee, sodas, candy, ice cream, alcohol, natural extracts and flavors.
